(19) United States
(12) Patent Application Publication
(10) Pub. No.: US 2012/0224265 A1
(43) Pub. Date: Sep. 6, 2012

(54) SUPPORTING A SUBSTRATE WITHIN AN OPTICAL COMPONENT

(76) Inventors: Stephan R. CLARK, Albany, OR (US); John P. Whitlock, Lebanon, OR (US)

(21) Appl. No.: 13/039,577

(22) Filed: Mar. 3, 2011

(51) Int. Cl. G02B 1/10

(52) U.S. Cl. 359/584

(57) ABSTRACT

An optical component including a substrate having a first side and a second side opposite the first side, a first plurality of light reflective coating layers disposed adjacent to the first side and a second plurality of light reflective coating layers disposed adjacent to the second side of the substrate. The first plurality of light reflective coating layers has a first combination of a first thickness and a first modulus of elasticity in relation to the substrate. The second plurality of light reflective coating layers has a second combination of a second thickness and a second modulus of elasticity in relation to the substrate that matches the first combination such that the first and second plurality of light reflective coatings layers support the substrate in a neutral shape.

### GOVERNMENT LICENSE RIGHTS

This invention was made with government support under Subcontract No. CW135971, under Prime Contract No. HR0011-07-9-0005, through the Defense Advanced Research Projects Agency (DARPA). The government has certain rights in the invention.

### BACKGROUND

In general, a dichroic filter is an optical filter used to selectively allow light of a certain range of wavelengths to pass there through while reflecting light having a wavelength outside of the “certain” range of wavelengths.

In a dichroic filter, alternating layers of optical thin films with different refractive indices and thicknesses are located on a substrate. Due to the refractive index of each material, which depends on wavelength and the physical thickness of the film that the light wave traverses, each wavelength of light will accumulate a different optical path length. In addition, at each layer interface a portion of the light will be reflected and a portion transmitted. The portion reflected or transmitted is determined by the index of refraction of the materials as well as the angle of incidence assuming non absorbing optical thin films. The physical length that the light wave travels combined with any phase shifts that occur due to the interface reflection will result in a net optical path length of that portion of the beam that is reflected or transmitted. As there are multiple interfaces and multiple reflections that the light ray can take, the resultant light wave out will be a combination of these reflections. These reflections can combine to reinforce certain wavelength reflectance or transmission or reduce the net reflectance or transmission for that wavelength. By controlling the thickness and number of the layers of optical coatings, the range of wavelengths (referred to as the “passband”) can be tuned to a desired range of wavelengths.

### DESCRIPTION OF THE DRAWINGS

The accompanying drawings, are incorporated in and form a part of the Description of Embodiments and illustrate various embodiments of the described technology and, together with the Description of Embodiments, serve to explain principles discussed below, where like designations denote like elements.

FIG. 1 is a block diagram of a light collecting system, according to an embodiment of the present technology.

FIG. 2 a cross-sectional view of an optical component, according to an embodiment of the present technology.

FIG. 3 is a block diagram representing an example operation of a light collecting system, according to an embodiment of the present technology.

FIG. 4 is a flow chart of an example method for supporting a substrate within an optical component, according to an embodiment of the present technology.

FIG. 5 is a flow chart of an example method for reflecting wavelengths of light by an optical component, according to an embodiment of the present technology.

The drawings referred to in this description should not be understood as being drawn to scale unless specifically noted.

### DESCRIPTION OF EMBODIMENTS

Reference will now be made in detail to embodiments, examples of which are illustrated in the accompanying drawings. While the description will refer to various embodiment(s), it will be understood that scope is not intended to limit to these embodiments. On the contrary, the embodiments described herein are intended to cover alternatives, modifications and equivalents, which may be included within the spirit and scope of the various embodiments as defined by the appended claims.

Furthermore, in the following detailed description, numerous specific details are set forth in order to provide a thorough understanding. However, various embodiments may be practiced without these specific details. In other instances, well known methods, procedures, components, and circuits have not been described in detail as not to unnecessarily obscure aspects.

The discussion will begin with a brief overview of an optical component, the architecture of which reduces bending and yellowing of the substrate within and increases efficiency with regards to collecting reflected light.

### Overview

In brief, embodiments described herein provide an optical component that utilizes a split coating architecture having a top and bottom coating disposed on a first and second side of a substrate, respectively. The top coating faces a light source and substantially blocks (reflects) ultraviolet light emitted from the light source, while passing longer wavelengths of light. The bottom coating then substantially blocks (reflects) these longer wavelengths of light, while possibly passing any ultraviolet light that leaked through the top coating.

Thus, ultimately, most of the ultraviolet light is reflected away from the top coating and never reaches the substrate. Substantially all of the remainder of the ultraviolet light that does leak through the top coating then passes through the substrate once before it exits the optical component through the bottom coating. As will be discussed further below, by reflecting ultraviolet light away from a substrate, embodiments reduce the yellowing of the substrate in ultraviolet light environments, thereby increasing an optical component's longevity.

Additionally, embodiments provide top and bottom coatings having thicknesses and a moduli of elasticity selected such that the substrate experiences a substantially equal amount of applied force from the top and bottom coatings. In this manner, the top and bottom coatings support the substrate in a neutral, non-bowing shape. Therefore, embodiments balance the coating stresses placed upon both sides of a substrate, thereby reducing bending and/or warping of the substrate.

The following discussion will begin with a description of the structure of some example components. The discussion will then be followed by a description of the components in operation.

### Structure

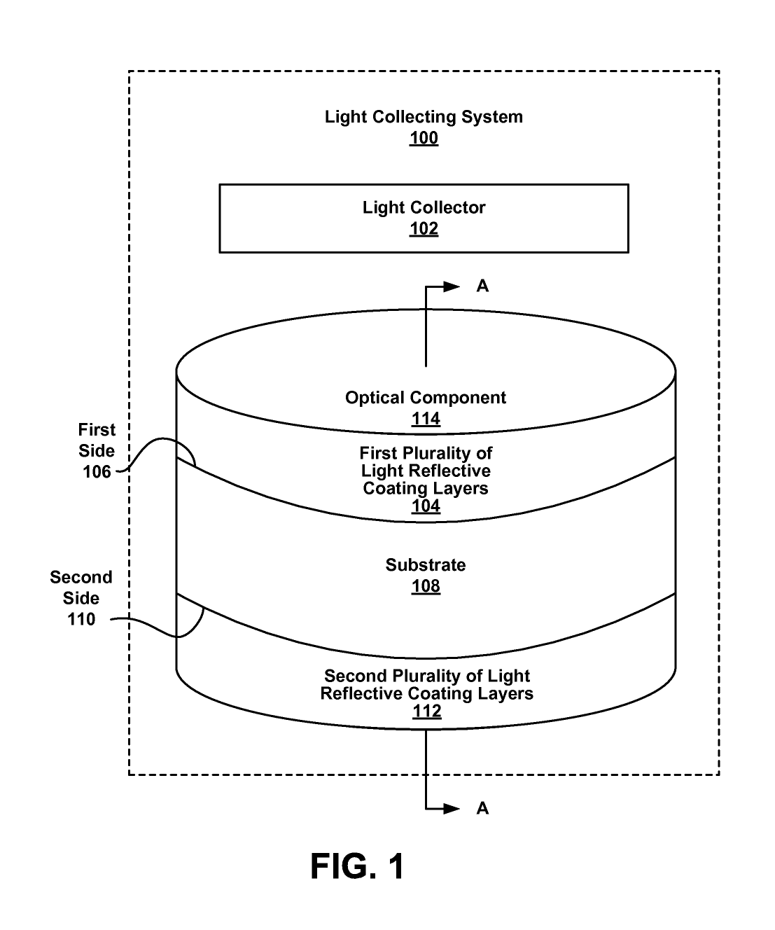

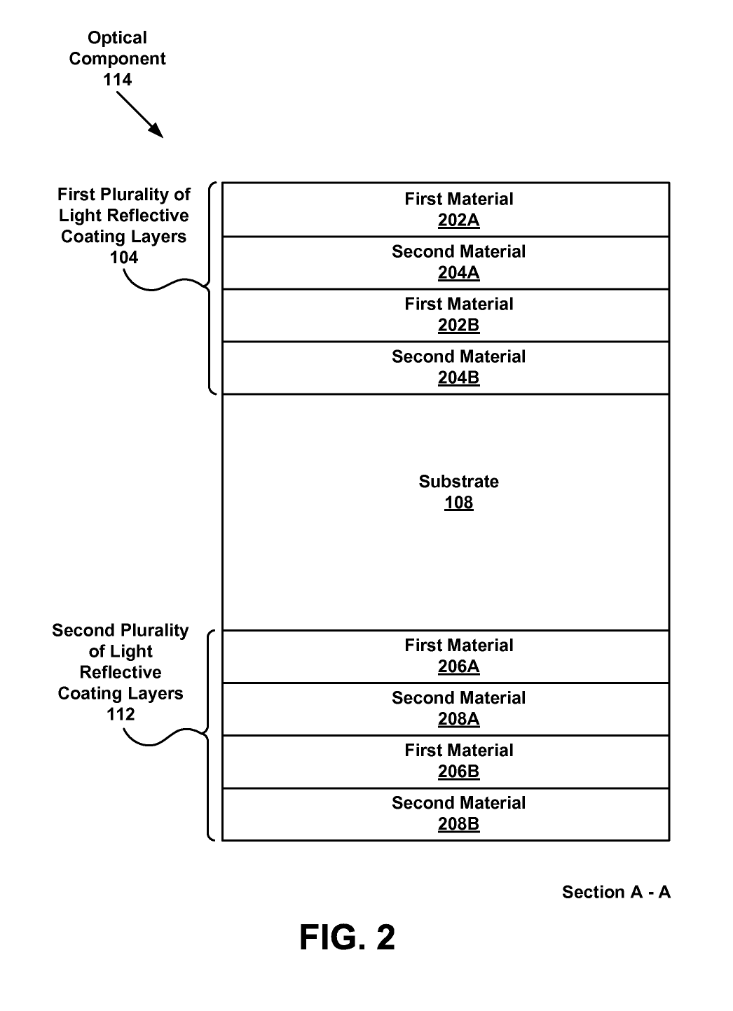

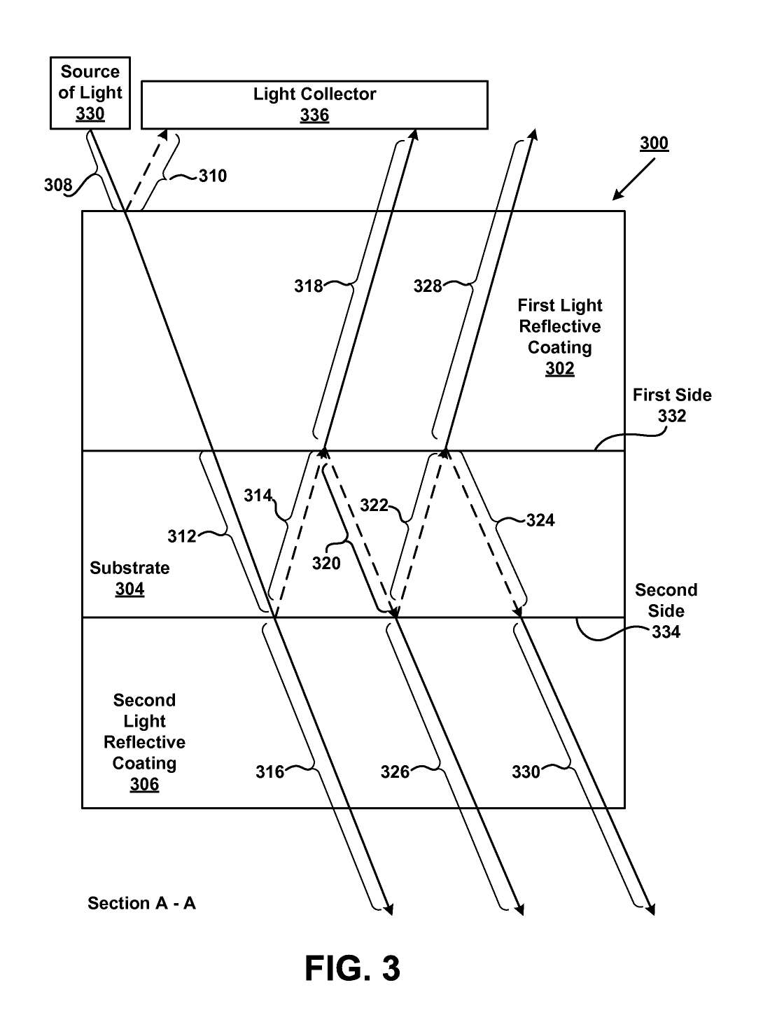

FIG. 1 is a block diagram of a light collecting system 100 including a light collector 102 and an optical component 114. In one embodiment, the light collector 102 collects reflected light, such as light reflected from the optical component 114, as will be described in more detail in the Operation section below. In another embodiment, the optical component 114 includes a substrate 108, a first plurality of light reflective coating layers 104 and a second plurality of light reflective coating layers 112. A set of section indicator lines indicates a direction of view of a cross-sectional view A-A of optical component 114 that is illustrated in FIGS. 2 and 3.

As shown in FIG. 1, in one embodiment, the substrate 108 has a first side 106 and a second side 110 opposite the first side 106. In one embodiment, the substrate 108 is plastic. In various embodiments, the substrate 108 is formed of a plastic material. In one such embodiment, the plastic material is a thin film. More specifically, according to one embodiment, the thin film plastic has a thickness ranging from 50 microns to 400 microns.

The first plurality of light reflective coating layers 104 is disposed adjacent to the first side 106 of the substrate 108. The first plurality of light reflective coating layers 104 reflects a first portion of light towards the light collector 102. In one embodiment, ultraviolet light is the first portion of light that is reflected from the light received at the optical component 114.

Still referring to FIG. 1, the second plurality of light reflective coating layers 112 is disposed adjacent to the second side 110 of the substrate 108. The second plurality of light reflective coating layers 112 reflects a second portion of light towards the light collector 102. In one embodiment, visible light is the second portion of light that is reflected from the light received at the optical component 114. It should be appreciated that the first and second portion may be portions of the light other than a distinct division between ultraviolet and visible light. For example, the first portion of light may be a mixture of ultraviolet and visible light. Likewise, the second portion of light may be a mixture of ultraviolet and visible light.

In one embodiment, the second portion of light reflected includes light of longer wavelengths than the first portion of light that is reflected. In other words, it is possible that the wavelengths of the first and second portion of light that are reflected overlap, while the second reflected portion maintains the characteristic of containing wavelengths that are longer than any wavelength found in the first reflected portion.

In various embodiments, the first and second plurality of light reflective coating layers, 104 and 112, respectively, support the substrate in a neutral shape. More specifically, in one such embodiment, the neutral shape is a flat shape. In other embodiments, the neutral shape is a non-flat shape.

Still with reference to FIG. 1, in one embodiment the first plurality of light reflective coating layers 104 may be defined by a first combination of a thickness and a modulus of elasticity in relation to the substrate and its modulus of elasticity. Additionally, the second plurality of light reflective coating layers 112 may be defined by a second combination of a thickness and a modulus of elasticity in relation to the substrate and its modulus of elasticity. For example, the forces induced by the first plurality of light reflective coating layers 104 and the forces induced by the second plurality of light reflective coating layers 112 counterbalance or neutralize one another. In other words, if a first light reflective coating layer on a first side 106 of substrate 108 has a first combination of the moduli of elasticity and the thickness that applies an internal stress to the substrate 108, a second light reflective coating layer on a second (opposing side) 110 of substrate 108 may be configured to provide a compensating stress. In this manner, the stresses imparted to substrate 108 by the top and bottom light reflective coating layers neutralize each other.

For example, in one embodiment, the first plurality of light reflective coating layers 104 may have twice the average modulus of elasticity relative to the substrate 108 as the resulting modulus of elasticity of the second plurality of light reflective coating layers 112 relative to the substrate 108. If a net stress is applied by the first plurality of light reflective layers to substrate 108, then the second plurality of light reflecting layers may then compensate the bowing effect of the stress from the first plurality of light reflecting layers by inducing the opposite stress on substrate 108. This may be accomplished by thickening the second plurality of light reflecting layers to make the same net strength as the first plurality of light reflecting layers while maintaining a similar film stress of the coating films. Thus, the increase in net thickness of the second light reflecting layer helps to offset the increase in net modulus on the first light reflecting layer. When this is applied to the opposite side of substrate 108, then the stresses on substrate 108 will be approximately equal and of opposite sign resulting in a net neutral or flat substrate. Due to this configuration (the combinations of moduli of elasticity and thicknesses), the force applied by the first plurality of light reflective coating layers 104 onto the first side 106 of the substrate 108 is roughly equivalent to the force applied by the second plurality of light reflective coating layers 112 onto the second side 110 of the substrate 108.

Thus, the stress applied onto the substrate (the area between the coating materials which is on and around a plastic substrate) due to the force applied by top and bottom light reflective coating layers results in a balanced scenario in which the substrate 108 is situated between two applied forces which counterbalance one another and thus support and maintain the substrate 108 in a non-bending shape. Therefore, by balancing out the force applied to the substrate by the top and bottom light reflective coating layers by providing compensating moduli of elasticity and geometry (e.g., thickness of the coating layers), the substrate is able to be supported and maintained in a neutral shape, which is not bent or warped by the forces imparted by the coating materials.

In one embodiment and as is demonstrated in the foregoing example, the thickness of the first plurality of light reflective coating layers 104 may be greater than the thickness of the second plurality of light reflective coating layers 112. In another embodiment, the thickness of the second plurality of light reflective coating layers 112 may be greater than the thickness of the first plurality of light reflective coating layers 104.

In comparison, conventional coating materials disposed upon a plastic substrate during the coating process impart an unbalanced stress load and cause the plastic substrate to distort when removed from the coating chamber. This stress is even more severe when the plastic substrate has to be elevated in temperature during the conventional coating process. For example, when the substrate temperature is elevated in the conventional coating process, the plastic substrate expands and the coating is formed on the expanded plastic substrate surface. Additionally, as the plastic substrate cools after being coated conventionally, the difference in the coefficient of thermal expansion (“CTE”) of the plastic substrate and the coating materials causes the coating materials to shrink at different rates, which results in different lengths of the plastic substrate and the coating.

These different lengths create stress in the part (in particular, in the substrate) and can distort the conventionally coated plastic substrate into some sort of bowed form. When the newly conventionally coated plastic substrate is elevated in temperature once again, the stress on the part changes and thus the distortion of the plastic substrate also changes, resulting in changes to the plastic substrate's bowed form. It should be noted that each optical thin film can have an internal stress due to the deposition parameters for that coating, imparting another stress to the substrate.

These problematic issues associated with the conventional plastic substrate-coating combination become even more prevalent when only one side of a plastic substrate is coated. In a conventional coating process, sometimes, in addition to a top coating material on one side of the substrate, an anti-reflection coating is disposed on the other side of the plastic substrate. However, in the conventional process the anti-reflection coating does not equalize the stress in the part resulting from the top coating. The typical number of thin film layers is lower for an anti reflection (AR) coating than for a dichroic bandpass coating. Thus, one would have to increase the thickness of the AR coating to balance the top layer. However, this would add more cost than is needed. Conversely, embodiments described herein enable stress applied by coatings of both sides of the substrate to be equalized, thereby preventing bending and warping that can occur in conventional coating processes.

FIG. 2 is a block diagram of the cross-section A-A (FIG. 1) of the optical component 114, according to various embodiments. More particularly, FIG. 2 shows a cross-section A-A of the first plurality of light reflective coating layers 104 and the second plurality of light reflective coating layers 112.

Referring now to FIGS. 1 and 2, in one embodiment, the first plurality of light reflective coating layers 104 includes a combination of alternating layers of a first material 202A and 202B (“202”) and a second material 204A and 204B (“204”). In one embodiment, the combination of the first material 202 and second material 204 is designed to minimize the force that is applied to the first side 106 of the substrate 108. In as much as the combination of the first and second material 202 and 204, respectively, does apply a force to the first side 106 of the substrate 108, even though minimized, the combination is designed to compensate for the net force being applied to the second side 110, as will be explained herein. In another embodiment, the combination of the first and second materials 202 and 204 is designed to compensate for the combination of forces applied to the second side 110 of the substrate 108. In one embodiment, the first material 202 and the second material 204 may apply higher and lower amounts of force, respectively, to the first side 106 of the substrate 108.

For example, but not limited to such, in one embodiment the first material 202 is titanium dioxide and the second material 204 is silicon dioxide. Titanium dioxide has a high index. However, the titanium dioxide creates a high amount of stress upon the substrate 108, which may cause the substrate 108 to bend. In contrast, the silicon dioxide has a low index. In contrast and relative to titanium dioxide, silicon dioxide creates less stress upon the substrate 108. Thus, the silicon dioxide, used in combination with the titanium dioxide, reduces the stress that the first plurality of light reflective coating layers 104 applies to the substrate 108, while also enabling fewer reflecting layers to be applied and still achieve the desired reflecting properties.

In another embodiment, the second plurality of light reflective coating layers 112 includes a combination of alternating layers of a first material 206A and 206B (“206”) and a second material 208A and 208B (“208”). In one embodiment, the combination of the first material 206 and second material 208 is designed to minimize the force that is applied to the second side 110 of the substrate 108. In as much as the combination of the first and second material 206 and 208, respectively, does apply a force to the second side 110 of the substrate 108, even though minimized, the combination is designed to compensate for the net force being applied to the first side 106, as is discussed herein. In another embodiment, the combination of the first and second materials 206 and 208 is designed to compensate for the combination of forces applied to the first side 106 of the substrate 108. In one embodiment, the first material 206 and the second material 208 may apply higher and lower amounts of force, respectively, to the second side 110 of the substrate 108.

As one non-limiting example, the first material 206 may be titanium dioxide while the second material 208 may be magnesium fluoride.

It should be appreciated that the first materials 202 and 206 and the second materials 204 and 208 of the first and second pluralities of light reflective coating layers, 104 and 112, respectively, may be of different material sets other than those described herein. The combination of these material sets is predetermined to afford a substantially equal force being applied to both the first side 106 and the second side 110 of the substrate 108 by the first and second pluralities of light reflective coating layers, 104 and 112, respectively, as well as minimizing the net force that each coating layer 104 and 112 applies on each side 106 and 110 independently.

Thus, a first plurality of light reflective coating layers 104 is disposed adjacent to a first side 106 of the substrate 108 and a second plurality of light reflective coating layers 112 is disposed adjacent to the second side 110 of the substrate 108, such that the force applied by the first and second light reflective coating layers, 104 and 112, respectively, onto the substrate 108 balance each other out. Further, by balancing out the forces applied to the first and second side 106 and 110, respectively, of the substrate 108, the substrate 108 itself is able to remain in a substantially flat shape. By substantially flat, it is meant that the substrate 108 is flat or is experiencing a minor amount of warping and/or bending but still appears to be flat.

In one embodiment, and as has been described herein, the neutral shape is flat. However, in other embodiments, the neutral shape is a predetermined shape that is something other than flat.

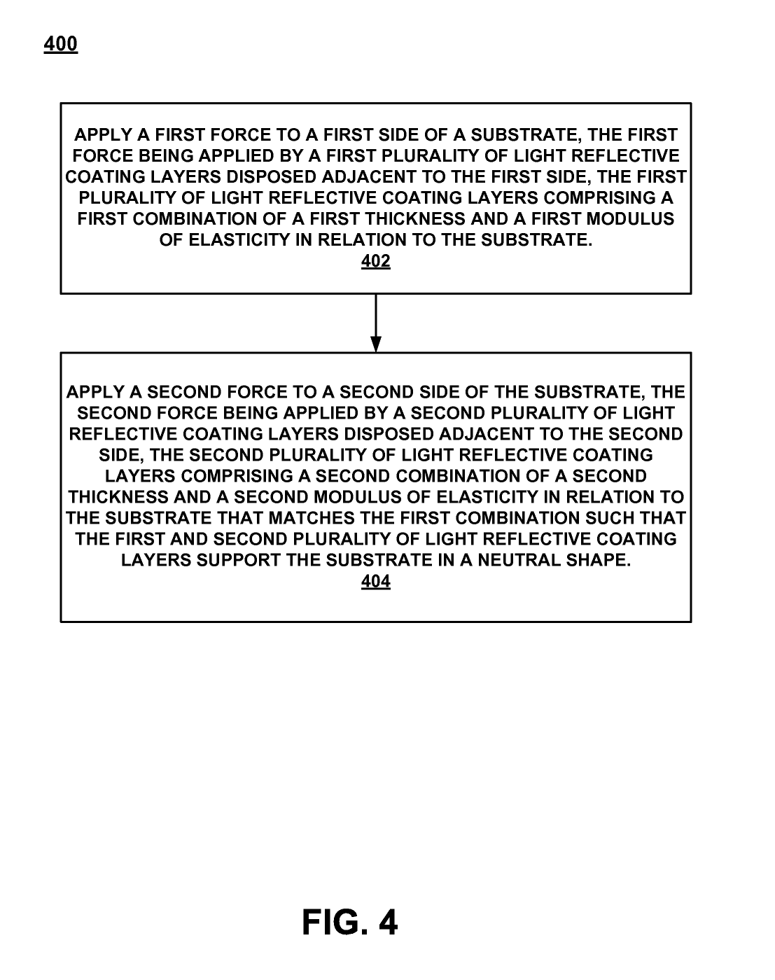

FIG. 4 shows a flow chart of an example method 400 for supporting a substrate within an optical component, in accordance with an embodiment of the present technology. With reference now to FIGS. 1, 2 and 4, at 402 and as described herein, one embodiment applies a first force to a first side 106 of a substrate 108, the first force being applied by a first plurality of light reflective coating layers 104 disposed adjacent to the first side 106. The first plurality of light reflective coating layers 104 comprises a first combination of a first thickness and a first modulus of elasticity in relation to the substrate 108. At 404 and as described herein, one embodiment applies a second force to a second side 110 of the substrate 108, the second force being applied by a second plurality of light reflective coating layers 112 disposed adjacent to the second side 110. The second plurality of light reflective coating layers 112 comprises a second combination of a second thickness and a second modulus of elasticity in relation to the substrate 108 that matches the first combination such that the first and second plurality of light reflective coating layers, 104 and 112, respectively, support the substrate 108 in a neutral shape.

With reference now to FIG. 3, a block diagram of a cross-section 338 of an optical component 300 is shown, in accordance with an embodiment. In one embodiment, the optical component 300 includes a substrate 304 including a first side 332 and a second side 334 opposite the first side 332. The first side 332 is configured for facing a source of light 330. In one embodiment, the optical component 300 also includes a first light reflective coating 302 and a second light reflective coating 306.

In yet another embodiment, the first light reflective coating 302 is disposed adjacent to the first side 332 of the substrate 304. The first light reflective coating 302 reflects a first range of wavelengths of light emitted from the source of light 330.

In various embodiments, the second light reflective coating 306 is disposed adjacent to the second side 334 of the substrate 304. The second light reflective coating 306 reflects a second range of wavelengths of light emitted from the source of light 330. The second range includes wavelengths longer than wavelengths of the first range such that the first and second light reflective coatings, 302 and 306, respectively, support the substrate 304 in a neutral shape. In one embodiment, a portion of the second range of wavelengths of light is reflected back through the substrate 304. In one embodiment, a portion of the second range of wavelengths of light is transmitted away from the substrate 304.

With reference still to FIG. 3, in one embodiment, a light collecting system includes both the light collector 336 and the optical component 300 described herein.

Thus, the split coating enables plastic sheets of substrate material to be coated flat, giving a high coating uniformity and accuracy. Further, embodiments enable such a coated plastic sheet to be formed accurately into a non-flat shape without cracking the coating.

Splitting the coating enables a very symmetric coating thickness on both sides of the plastic substrate, thus balancing any stress created by the coating process and allowing for a flatter plastic film to be used in the coating chamber. Thus, with a more balanced stress applied to the plastic substrate, the formation of the plastic substrate into an optical concentrator can be done with more accuracy. The ultraviolet blocking coating layer formed on the plastic substrate reduces and delays the occurrence of the yellowing that is typical of plastics. Thus, embodiments described herein enable the plastic substrate to be used in an ultraviolet light environment.

### Operation

With reference still to FIG. 3, the optical component 300 in operation will be described. The first light reflective coating 302 is designed to reflect ultraviolet light. By way of example and not of limitation, in one embodiment, the first light reflective coating 302 is designed to reflect wavelengths of light up to about 500 nanometers. Since the longest wavelengths for ultraviolet light are approximately 400 nanometers, it is likely that the first light reflective coating 302 reflects a large portion of the ultraviolet light emitted from the source of light 330.

For purposes of illustration only, percentages will be applied to this example. However, it should be understood that these percentages are not exact and are merely meant for illustration. Reflection 310 shows the reflection of 70% of the ultraviolet light. Thus, about 30% of the UV light passes (shown at 312) through the first light reflective coating 302 and some undefined percentage of longer wavelength light to reach the second light reflective coating 306, as seen at 334 (second side of substrate 304). In this example, as of yet, the light collector 336 collects the net reflected ultraviolet light 310.

It should be appreciated that the reflection 310 of FIG. 3 is the resultant wave from all the bounces of light off of the individual material layers within the first and second light reflective coatings 302 and 306, respectively. In other words, the reflection 310 represents the net reflected wave of the light reflected from the individual material layers within the first and second light reflective coatings 302 and 306. Likewise, all reflections represented by lines 310, 314, 320, 322 and 324 are also net reflected waves resulting from reflections from individual material layers within the first and second light reflective coatings 302 and 306.

Further, in this example, 30% of the UV light 308 emitted from the light source 330, and the longer wavelengths of light 308 emitted from the light source 330, pass through the first light reflective coating 302 and reach the second light reflective coating 306. The second light reflective coating 306, by way of example, is designed to reflect 97% of those wavelengths that are between 500 and 850 nanometers, which include visible light. Reflection 314 illustrates the reflection of 97% of the visible light that had reached the second light reflective coating 306. On the other hand, transmitted light 316, which consist of 3% of the combined 312 visible light and some undefined percentage of the ultraviolet light that passed through the first light reflecting layer now pass through the second light reflective coating 306.

The reflected visible light 314 reaches the edge 332 of the first light reflective coating 302. As described in this example, the first light reflective coating 302 is designed to reflect 70% of any wavelength that is shorter than 550 nanometers. Thus, at reflection 320, the resulting wave of the multiple reflections inside first light reflective coating 302, 70% of whatever wavelengths that are shorter than 550 nanometers is reflected back towards the second light reflective coating. The remaining 30% of the combined reflected ultraviolet light and visible light of 314 passes through the first light reflective coating 302 as seen by transmitted light 318, and is also collected by the light collector 336.

Next, a portion of whatever ultraviolet light that passed through the first light reflective coating 302 at 312 and managed to be reflected by the second light reflective coating 306 at 314, now may be reflected again by the substrate side of the first light reflective coating 302 in the reflection shown at 320.

This pattern of reflection continues to repeat itself at 322, 326, 328, 324 and 330 and etc. until no more light exists to be reflected.

It is significant to note that if the light being emitted from the light source 330 hits the coating substrate coating combination at an angle, each pass will result in an off-set of a subsequent light beam from the previous light beam. In this manner, it can be seen that only the first few reflections at 310 and 318 from the first and second light reflective coatings 302 and 306, respectively, are collected by the light collector 336 the actual number will depend on the light collector size. Laterally, the off-set light beams will eventually move away from the face of the light collector 336. However, as described, it is the first few reflections, at 310 and 318, towards the light collector 336 that hold the most light and thus create the most power.

Furthermore, the combination of the first and second light reflective coatings 302 and 306, respectively, and their relationship with each other reduce the amount of light that interacts with the substrate 304, thus reducing undesirable yellowing. Therefore, embodiments as described herein expand the life of the substrate, thereby reducing costs.

To make a split coating work more optimally, the first light reflecting coating has a narrow wavelength region where it has a high reflectance. This is typically in the ultraviolet and blue wavelength regions. The second light reflecting coating will then predominately reflect longer wavelength light. The reflectance in the blue/ultraviolet region is less important as the first light reflecting layer does the majority of the reflection in this region. Because of the way the light reflects from the two light reflecting coatings 302 and 306 there will be a dip in the net performance of the two coatings. This can be illustrated with the following example.

With reference still to FIGS. 1 through 3, in another non-limiting example of operation, light in the 600 nanometer range is directed to the optical component configured in accordance with an embodiment. Also, in line with this non-limiting example, the first light reflective coating 302 reflects 20% of the light and passes 80% of the light to the second light reflective coating 306.

95% of the light 312 is reflected from the second light reflective coating 306. This reflected light at 314, is reflected back up to meet the first light reflective coating 302, only to have 80% of reflected light 314 pass through (at 318) and out of the first light reflective coating 302.

For solar concentrators of high concentration, only the first bounce (reflectance) off the second light reflective coating may typically be used (e.g., reflected light 318). This is because the reflected second beam of light (e.g., reflected light 328) will be defocused and offset from the first beam of light on each subsequent bounce after the first and will thus walk off of the photovoltaic cell, and not be converted to electrical energy. Following the most recent example given herein, a 20% reflectance off the first light reflective coating 302 and 60.8% reflectance (0.8*0.95*0.8=0.608) of the first bounce off the second light reflective coating 306 results in 80.6% total reflection of light in the 600 nanometer range. In this example, the 600 nm light is in the cross over region, i.e. the region where the two coatings transition from lower reflectance to higher reflectance. Thus, a reduction in reflectance from that of the second light reflecting layer when in a lower reflectance window of the first light reflecting coating is shown. Therefore, a sharper transition from high to low reflectance is needed for the first light reflecting coating to obtain a net high reflectance in band dichroic coating.

In one embodiment, the out of band reflectance for the first light reflective coating is kept as low as possible. Further, in one embodiment, the cross over region of the first range of wavelengths to the second range of wavelengths is kept as small in width (i.e., wavelength range) as possible, in order to keep the net reflectance as high as possible. To accomplish this crossover narrowing, in one embodiment, the predetermined maximum wavelength blocked by the first light reflective coating is close to the 450-500 nm region. This tends to allow for a thinner first light reflecting coating with a sharper transition.

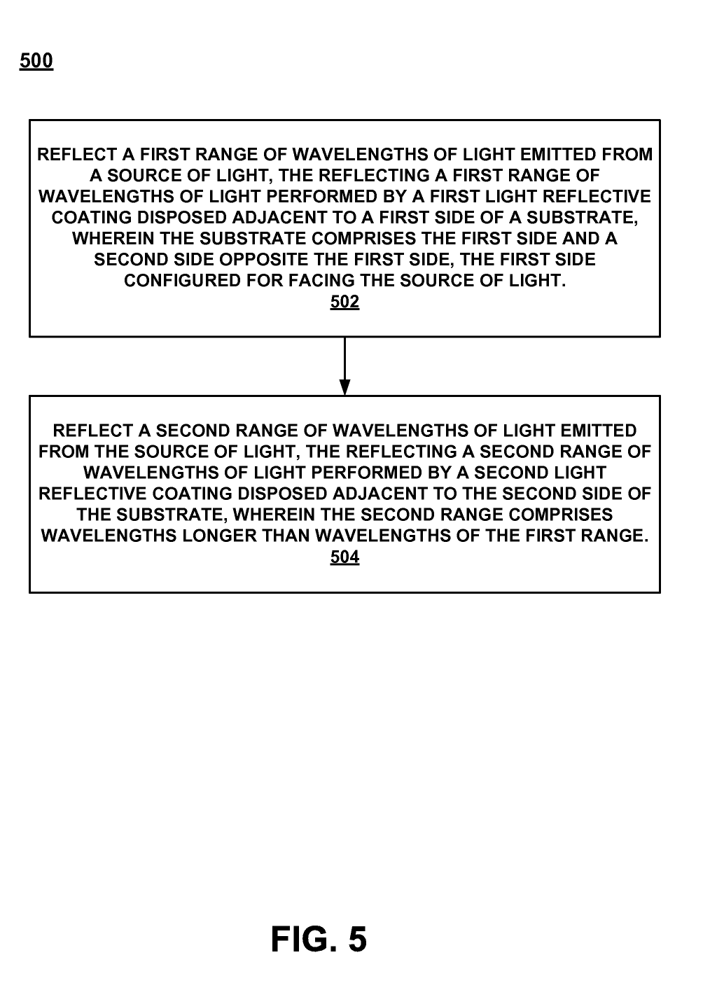

FIG. 5 shows a flow chart of an example method for reflecting wavelengths of light by an optical component, in accordance with an embodiment of the present technology. With reference now to FIGS. 3 and 5, at 502 and as described herein, one embodiment reflects a first range of wavelengths of light emitted from a source of light 330. The reflecting is performed by a first light reflective coating 302 disposed adjacent to a first side 332 of a substrate 304. The substrate 304 comprises the first side 332 and a second side 334 opposite the first side 332, wherein the first side 332 is configured for facing the source of light 330.

With reference still to FIGS. 3 and 5 and as described herein, at 504 one embodiment reflects a second range of wavelengths of light emitted from the source of light 330. The reflecting is performed by a second light reflective coating 306 disposed adjacent to the second side 334 of the substrate 304, wherein the second range comprises wavelengths longer than wavelengths of the first range.

Thus, a split coating provides architecture that enables ultraviolet susceptible materials to be used reliably where high ultraviolet illumination exists. For example, embodiments may be used in an optical system, such as but not limited to, a solar concentrator. Further embodiments enable a symmetric coating on both sides of a thin substrate that reduces substrate bending due to coating stress and coefficient of thermal expansion differences between the substrate and the coating materials.

All statements herein reciting principles, aspects, and embodiments, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the material described herein, therefore, is not intended to be limited to the exemplary embodiments shown and described herein. Rather, the scope and spirit is embodied by the appended claims.

What we claim is:

1. An optical component comprising:
a substrate comprising a first side and a second side opposite said first side;
a first plurality of light reflective coating layers disposed adjacent to said first side, said first plurality of light reflective coating layers comprising a first combination of a first thickness and a first modulus of elasticity in relation to said substrate; and
a second plurality of light reflective coating layers disposed adjacent to said second side, said second plurality of light reflective coating layers comprising a second combination of a second thickness and a second modulus of elasticity in relation to said substrate that matches said first combination such that said first and second plurality of light reflective coating layers support said substrate in a neutral shape.

2. The optical component of claim 1, wherein said first and second plurality of light reflective coating layers apply a substantially equal force to said first and second side, respectively.

3. The optical component of claim 1, wherein said first plurality of light reflective coating layers is thicker than said second plurality of light reflective coating layers.

4. The optical component of claim 1, wherein said second plurality of light reflective coating layers is thicker than said first plurality of light reflective coating layers.

5. The optical component of claim 1, wherein said substrate is a thin film plastic.

6. The optical component of claim 5, wherein said thin film plastic ranges in thickness from 50 microns to 400 microns.

7. The optical component of claim 1, wherein said first plurality of light reflective coating layers comprises a combination of alternating layers of a first and second material, said first and second material configured for applying at least one of minimized forces and compensating forces to said substrate.

8. The optical component of claim 1, wherein said second plurality of light reflective coating layers comprises a combination of alternating layers of a first and second material, said first and second material configured for applying at least one of minimized forces and compensating forces to said substrate.

9. The optical component of claim 1, wherein said neutral shape is flat.

10. A light collecting system comprising:
a light collector configured for collecting reflected light; and
an optical component comprising:
a substrate comprising a first side and second side opposite said first side;
a first plurality of light reflective coating layers disposed adjacent to said first side, said first plurality of light reflective coating layers configured for reflecting a first portion of light towards said light collector; and
a second plurality of light reflective coating layers disposed adjacent to said second side, said second plurality of light reflective coating layers configured for reflecting a second portion of said light towards said light collector, said first and second plurality of light reflective coating layers supporting said substrate in a neutral shape.

11. The light collecting system of claim 10, wherein said first plurality of light reflective coating layers comprising a first combination of a first thickness and a first modulus of elasticity in relation to said substrate, and said second plurality of light reflective coating layers comprising a second combination of a second thickness and a second modulus of elasticity in relation to said substrate that matches said first combination.

12. The light collecting system of claim 10, wherein said first plurality of light reflective coating layers of said optical component comprises a combination of alternating layers of a first and second material, said first and second material configured for applying at least one of minimized forces and compensating forces to said substrate.

13. The light collecting system of claim 10, wherein said second plurality of light reflective coating layers of said optical component comprises a combination of alternating layers of a first and second material, said first and second material configured for applying at least one of minimized forces and compensating forces to said substrate.

14. The light collecting system of claim 10, wherein said substrate is plastic.

15. An optical component comprising:
a substrate comprising a first side and a second side opposite said first side, said first side configured for facing a source of light;
a first light reflective coating disposed adjacent to said first side, said first light reflective coating configured for reflecting a first range of wavelengths of light emitted from said source of light; and
a second light reflective coating disposed adjacent to said second side of said substrate, said second light reflective coating configured for reflecting a second range of wavelengths of light emitted from said source of light, said second range comprising wavelengths longer than wavelengths of said first range.

16. The optical component of claim 15, wherein said first light reflective coating comprises a first combination of a first thickness and a first modulus of elasticity in relation to said substrate, and said second light reflective coating comprises a second combination of a second thickness and a second modulus of elasticity in relation to said substrate that matches said first combination, wherein said first and second light reflective coatings support said substrate in a neutral shape.

17. The optical component of claim 16, wherein said neutral shape comprises a predetermined shape supported in place by a predetermined combination of said first and second light reflective coatings.

18. The optical component of claim 17, wherein said predetermined shape is flat.

19. The optical component of claim 15, wherein a portion of said first range of wavelengths of light is reflected away from said substrate.

20. The optical component of claim 15, wherein a portion of said first range of wavelengths of light is transmitted toward said substrate.
